(19) United States
(12) Patent Application Publication
(10) Pub. No.: US 2023/0180089 A1
(43) Pub. Date: Jun. 8, 2023

(54) EFFICIENT CELL RESELECTION DURING PANIC MODE IN A 5G STANDALONE MODE

(71) Applicant: QUALCOMM Incorporated, San Diego, CA (US)

(72) Inventors: Neeraj PANWAR, San Diego, CA (US); Srividhya SHANMUGAM, San Diego, CA (US); Anuj VYAS, San Diego, CA (US); Kiran Kumar RAAVI, San Diego, CA (US)

(21) Appl. No.: 17/922,420

(22) PCT Filed: May 17, 2021
(86) PCT No.: PCT/US2021/032823

§ 371 Date: Oct. 31, 2022

(30) Foreign Application Priority Data
May 23, 2020 (IN) 202041021729

(51) Int. Cl. H04W 36/30; H04W 48/12; H04W 48/16; H04W 36/00

(52) U.S. Cl. CPC H04W 36/30; H04W 48/12; H04W 48/16; H04W 36/0085

(57) ABSTRACT

Wireless communications apparatus and methods configured to facilitate efficient cell reselection by a user equipment camped on a serving cell of a 5G new radio base station in a panic mode are provided. Aspects of the present disclosure include limiting the number of beams of a neighboring cell that may be measured as part of a cell reselection evaluation process to determine whether the neighboring cell is a suitable cell on which the user equipment can camp.

### CROSS-REFERENCE TO RELATED APPLICATIONS

The present application claims priority to Indian Provisional Patent Application No. 202041021729, filed May 23, 2020, titled “Efficient Cell Reselection During Panic Mode in a 5G Standalone Mode,” which is hereby incorporated by reference in its entirety as if fully set forth below and for all applicable purposes.

### INTRODUCTION

Wireless communications systems are widely deployed to provide various types of communication content such as voice, video, packet data, messaging, broadcast, and so on. A wireless multiple-access communications system may include a number of base stations (BSs), each simultaneously supporting communication for multiple communication devices, which may be otherwise known as user equipment (UE).

In a radio access network such as a network using new radio (NR) technology, a BS may transmit signals to allow UEs to search and connect with a cell within the radio access network. The UE may perform signal measurements and cell search, and may do so while attempting to conserve power. For example, the UE may employ the so-called discontinuous reception (DRX) technique during its search. During DRX, a UE may be in a DRX idle mode for a certain period of time and enter an active mode for another period of time. The DRX cycle allows the UE to power down certain radio components or at least switch certain radio components to a lower power state than when in an active state.

In some cases, after camping on a serving cell, the UE may determine that a neighboring cell has a better signal quality than the serving cell. For example, the serving cell may have inferior signal quality due to subpar communication channels or UE mobility (e.g. UE being at the edge of the serving cell). The UE may enter panic mode (for example, after a small duration or a few DRX cycles) and attempt to identify a neighboring cell with a better signal quality than that of the serving cell. In such cases, unless a suitable neighboring cell is found quickly during the cell search, the UE may determine that service is unavailable, resulting in broken network connectivity for the UE. As such, there is a need for methods, devices, and systems to facilitate efficient cell reselection by a UE in a panic mode.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A user equipment (UE) camping on a serving cell of a 5G new radio (NR) base station (BS) may enter panic mode after some time because of mobility of the UE, bad channel conditions in the serving cell, etc. The UE may receive a cell reselection information from the BS and use the information to search for more suitable neighboring cells. For example, the cell reselection information may include system information blocks (SIBs), which include information related to the number of beams of the neighboring blocks that the UE may measure to determine whether the neighboring cell is a suitable cell to camp on (e.g., if the neighboring cell has signal quality superior to that of the serving cell by some threshold amount). In some aspects, the UE may measure less number of beams of the neighboring cell that specified in the SIBs so as to reselect a neighboring cell more efficiently, i.e., quickly, with less power consumption, etc.

Aspects of the present disclosure disclose a method of wireless communication performed by a user equipment (UE). The method comprises camping in a panic mode on a serving cell of a 5G new radio (NR) base station (BS). The method further comprises receiving from the 5G NR BS cell reselection information including a first number of beams of a plurality of beams associated with a neighboring cell and configured to be measured for cell reselection of the neighboring cell. The method further comprises measuring a signal quality metric of each beam of a second number of beams of the plurality of beams to identify a number of beams suitable for cell reselection, the second number of beams being less than the first number of beams of the plurality of beams. The method also comprises triggering reselection of the neighboring cell based on the identified number of beams suitable for cell reselection.

In an aspect of the disclosure, a method of wireless communication performed by a user equipment (UE) is disclosed. The method comprises camping in a panic mode on a serving cell of a 5G new radio (NR) base station (BS), the serving cell associated with a serving cell beam. The method further comprises receiving from the 5G NR BS cell reselection information including a first number of beams of a plurality of beams associated with a neighboring cell and configured to be measured for cell reselection of the neighboring cell. The method further comprises sequentially measuring a signal quality metric of each beam of a second number of beams of the plurality of beams until a first beam of the second number of beams that is suitable for cell reselection is identified. The signal quality metric of the first beam can exceed the signal quality metric of the serving cell beam by a threshold amount, and the second number of beams can be less than the first number of beams of the plurality of beams. The method also comprises triggering reselection of the neighboring cell based on the measured signal quality metric of the first beam.

Aspects of the present disclosure disclose a user equipment (UE), comprising: a transceiver configured to receive, 5G new radio (NR) base station (BS), cell reselection information including a first number of beams of a plurality of beams associated with a neighboring cell and configured to be measured for cell reselection of the neighboring cell. Thee UE further comprises a processor configured to: camp in a panic mode on a serving cell of the 5G NR BS; measure a signal quality metric of each beam of a second number of beams of the plurality of beams to identify a number of beams suitable for cell reselection, the second number of beams being less than the first number of beams of the plurality of beams; and trigger reselection of the neighboring cell based on the identified number of beams suitable for cell reselection.

In an aspect of the disclosure, a UE comprising a transceiver and a processor is disclosed. The transceiver can be configured to receive, from a 5G new radio (NR) base station (BS), cell reselection information including a first number of beams of a plurality of beams associated with a neighboring cell and configured to be measured for cell reselection of the neighboring cell. The processor can be configured to camp in a panic mode on a serving cell of the 5G NR BS, the serving cell associated with a serving cell beam, and sequentially measure a signal quality metric of each beam of a second number of beams of the plurality of beams until a first beam of the second number of beams that is suitable for cell reselection is identified. The signal quality metric of the first beam can exceed a signal quality metric of the serving cell beam by a threshold amount; and the second number of beams can be less than the first number of beams of the plurality of beams. The processor can be further configured to trigger reselection of the neighboring cell based on the measured signal quality metric of the first beam.

Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communications network according to some aspects of the present disclosure.

FIG. 2 illustrates a wireless communication network according to some aspects of the present disclosure.

FIG. 3 illustrates a signaling diagram illustrating a cell reselection method according to some aspects of the present disclosure.

FIG. 4 is a block diagram of a user equipment (UE) according to some aspects of the present disclosure.

FIG. 5 is a block diagram of a base station (BS) according to some aspects of the present disclosure.

FIG. 6 is a flow diagram of a method of wireless communication according to some aspects of the present disclosure.

FIG. 7 is a flow diagram of a method of wireless communication according to some aspects of the present disclosure.

FIG. 8 is a flow diagram of a method of wireless communication according to some aspects of the present disclosure.

FIG. 9 is a schematic graph diagram illustrating a cell reselection method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1 M nodes/km²), ultra-low complexity (e.g., ˜10 s of bits/sec), ultra-low energy (e.g., ˜10+years of battery life), and deep coverage with the capability to reach challenging locations; (2) including time-stringent control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing (SCS), may efficiently address operating diverse services across diverse spectrum and diverse deployments. For example, in various outdoor and macro coverage deployments of less than 3 GHz FDD/TDD implementations, SCS may occur with 15 kHz, for example over 5, 10, 20 MHz, and the like bandwidth (BW). For other various outdoor and small cell coverage deployments of TDD greater than 3 GHz, SCS may occur with 30 kHz over 80/100 MHz BW. For other various indoor wideband implementations, using a TDD over the unlicensed portion of the 5 GHz band, the SCS may occur with 60 kHz over a 160 MHz BW. Finally, for various deployments transmitting with mmWave components at a TDD of 28 GHz, the SCS may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects or examples set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

The present disclosure describes mechanisms for preventing a UE that has entered panic mode in a 5G NR network in a standalone (SA) mode from entirely disconnecting from the network due to failed connection attempts. In contrast to a non-standalone (NSA) mode where a UE communicates to a LTE BS for control plane functionality and a 5G NR BS for data plane communication, in SA mode, the UE communicates to the 5G NR BS for both control plane functionality and data plane communication. The UE may camp on a serving cell in a 5G NR network, but may discover that the serving cell provides poor connectivity. For example, the serving cell may have subpar channel conditions, or the UE may have moved within the serving cell to where the serving cell has poor connectivity (e.g., towards the edge of the serving cell), etc. As discussed below, the term “cell” can refer to a particular geographic coverage area of a 5G NR BS and/or a BS subsystem serving the coverage area, depending on the context in which the term is used. The UE may enter panic mode based on criteria of the serving cell and attempt to identify a neighboring cell with a better signal quality than that of the serving cell. For example, the criteria may be that the UE can enter a panic mode if the SNR of the channel is less than a threshold (e.g., −6 dB), and may allow the UE to enter a panic mode after a number of DRX cycles (e.g., 4 cycles) or after a duration (e.g., 10 seconds). During DRX, a UE may be in a DRX idle mode for a certain period of time and enter an active mode for another period of time. The DRX cycle allows the UE to power down certain radio components or at least switch certain radio components to a lower power state than when in an active state. If a suitable neighboring cell is not found quickly while the UE is in panic mode, the UE may determine that service is unavailable and enter an “out of service” mode. To identify a suitable neighboring cell while in the panic mode, the UE may receive from the NR BS cell reselection information about the neighboring cell.

In a wireless communication network, a NR BS serving a cell may broadcast system information, for example, in the form of master information block (MIB) and system information blocks (SIBs) to facilitate communications with UEs in the cell. The system information may include neighboring cell information, for example, indicating one or more intra-frequency neighboring cells, one or more inter-frequency neighboring cells, and/or one or more inter-frequency neighboring cells to the serving cell. As discussed in more detail below, cell reselection information related to intra-frequency cell reselection (i.e., cell reselection within the same operating carrier frequency as that of the serving cell and inter-frequency cell reselection (i.e., cell reselection to an operating carrier frequency different than that of the serving cell) may be included in SIB type 2 (“SIB2”) and SIB type 4 (“SIB4”), respectively. For example, SIB2 and SIB4 may include configured values for the number of synchronization signal blocks to average for cell measurement derivation (nrofSS-BlocksToAverage), which indicate the number of neighboring cell beams to be measured by the UE as part of the UE's cell reselection determination. If nrofSS-BlocksToAverage is not configured, a UE may measure all the beams in the neighboring cell to identify the highest quality beam for the cell reselection evaluation.

When the UE is in panic mode, however, it may not be desirable to measure as many beams in a neighboring cell as specified by nrofSS-BlocksToAverage, or all the beams (e.g., when nrofSS-BlocksToAverage is not configured) for the cell reselection determination. This is because the measurement process may take a significant amount of time, and may result in broken network connectivity for the UE if a suitable neighboring cell is not found quickly enough. Further, the measurement process may increase the UE's power consumption. In some aspects of the present disclosure, methods, apparatus and systems that facilitate efficient cell reselection by a UE camping in panic mode on a serving cell are disclosed.

In some aspects of the present disclosure, a UE camps in a panic mode on a serving cell and receives cell reselection information from a NR BS about a cell neighboring the serving cell. The cell reselection information can include a configured value of nrofSS-BlocksToAverage specifying the number of beams to be measured in the neighboring cell as part of the cell reselection determination. The UE may then measure, as part of the cell reselection evaluation, a number of beams in the neighboring cell less than specified by the configured value of nrofSS-BlocksToAverage (or, if nrofSS-BlocksToAverage is not configured, less than the total number of beams in the neighboring cell). For example, the UE may sequentially measure the beams in the neighboring cell to identify or discover a beam that has better signal quality than the signal quality of the serving cell beam by a threshold amount. In some aspects, measuring the signal qualities may refer to measuring a reference signal received power (RSRP), a reference signal received quality (RSRQ), signal-to-noise ratio (SINR), etc., of a beam. Once the UE identifies or discovers such a beam, the UE may not proceed with measuring the signal qualities of the rest of the beams in the neighboring cell, and instead may use the signal quality measurement of the identified beam to trigger cell reselection of the neighboring cell as discussed below. The threshold amount of signal quality may be selected to, for example, prevent the ping-pong effect, i.e., the rapid and successive switching of the UE from one cell to another in search of an ever better signal quality.

In some aspects, after identifying a first beam of the neighboring cell that has better signal quality than the signal quality of the serving cell beam by the threshold amount, the UE may proceed to sequentially measure additional beams of the neighboring cell until the UE identifies a beam with a signal quality that does not exceed the signal quality of the beam measured immediately prior to it. In other words, the UE ceases measuring the signal quality of the beams of the neighboring cell once the UE identifies a beam that has a worse signal quality than the beam measured immediately prior to it. In such cases, the UE may use the signal quality measurements of the first beam as well as the measured additional beams (e.g., excluding the signal quality measurement of the beam that has the worse signal quality than the beam measured immediately prior to it) to trigger cell reselection of the neighboring cell.

Aspects of the present disclosure can provide several benefits. For example, network connectivity of a UE (e.g., in a panic mode) may improve as the UE may not entirely disconnect from the NR BS for taking too long to find a suitable cell with at least adequate signal quality. That is, because the amount of time that the UE spends measuring beam signal qualities as part of the cell reselection process is reduced (e.g., because the UE measures the signal qualities of a number of beams less than specified in cell reselection information), the UE may be able to connect with the NR BS before having to decide the network or the NR BS is out of service. Further, power efficiency at the UE may be improved as the UE measures fewer number of beams in the neighboring cell than specified by the cell selection information. As such, the techniques provided in the present disclosure may achieve at least an improved network connectivity and UE power and mobility performance.

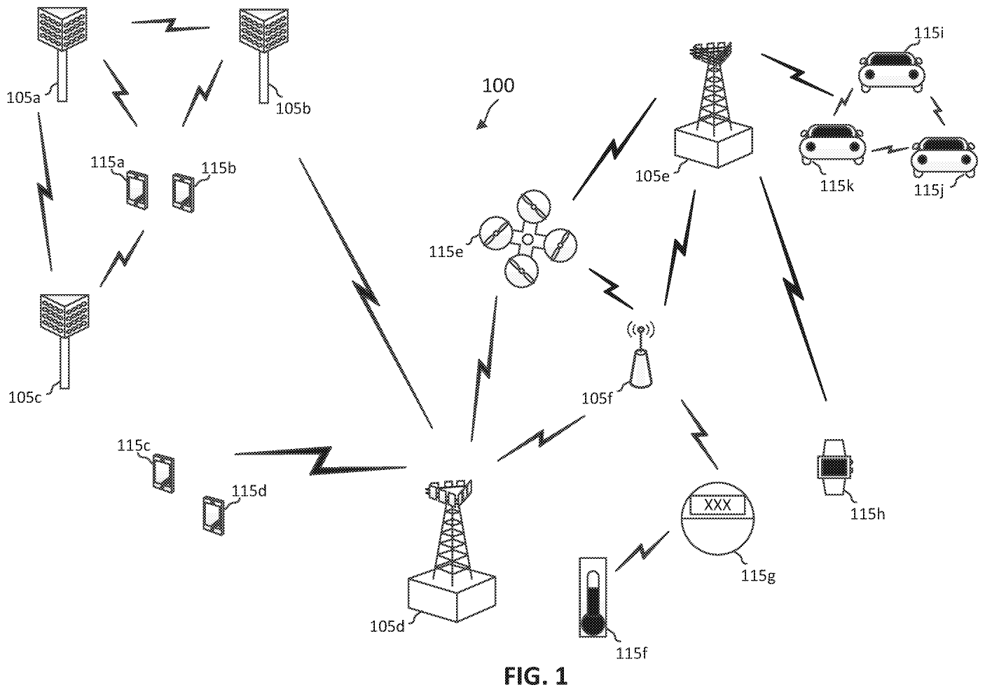

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmit multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support time-stringent communications with ultra-reliable and redundant links for time-stringent devices, such as the UE 115e, which may be an unmanned vehicle/aircraft. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X) communications, cellular-V2X (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing (SCS) between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. A subframe may also be referred to as a slot. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB, which may be transmitted in the physical broadcast channel (PBCH). The MIB may include system information for initial network access and scheduling information for RMSI and/or OSI. After decoding the MIB, the UE 115 may receive RMSI, OSI, and/or one or more system information blocks (SIBs). The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS. In some aspects, SIB1 may contain cell access parameters and scheduling information for other SIBs.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. When the UE 115 is actively exchanging data with the BS 105, the UE 115 is in an RRC connected state. In some aspects, the BS 105 may communicate with a UE 115 using HARQ techniques to improve communication reliability, for example, to provide a URLLC service.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative-acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the UEs 115 may be operated by multiple network operating entities.

The network 100 may operate over a shared channel, which may include a licensed spectrum, a shared spectrum, and/or an unlicensed spectrum, and may support dynamic medium sharing. The shared channel may be located at frequencies of about 5-6 GHz or above 6 GHz. When a BS 105 operates at a high-frequency range, the BSs 105 may communicate with the UEs 115 using directional beams to overcome the high path-loss in the high-frequency range. Each cell may transmit one or more synchronization signal blocks (SSBs). Each SSB may carry information including a PSS, a SSS, a PBCH signal, a cell ID for the SSB, a current beam index, a measurement window timing, and/or any discovery related reference signals.

A BS 105 may transmit a synchronization signal burst set (SSBS) within a synchronization block measurement timing configuration (SMTC) window. The BS 105 may configure the UE 115 with a SMTC window. The SSBS may include a number of SSBs, each SSB being transmitted over a given beam. Information may be kept substantially similar and consistent through all SSBs in a SSBS. Each SSB may be assigned with a unique number within the SSBS. For example, N SSBs in a SSBS are indexed, for example, from 0 to N−1, where N is a number greater than 1. A BS 105 may transmit a SSBS at certain locations within a measurement window (e.g., SMTC window). A BS 105 may transmit each SSB within a SSBS using a different beam direction. A beam index is assigned to each beam direction.

The UE 115 may monitor for SSBs within the SMTC window. To reduce power consumption, the UE 115 may operate in a discontinuous reception (DRX) mode. In a wireless communication network, DRX is a technique in which the UE 115 may enter an idle mode for a certain period of time and enter an active mode for another period of time. While the UE 115 is in active mode, the UE 115 may monitor for physical DL control channel (PDCCH) from a serving BS and decode PDCCH received from the BS. While the UE 115 is in idle mode, the UE 115 may not monitor for PDCCH, thus allowing the UE 115 to power down certain radio components or at least switch certain radio components to a lower power state than an active state. Accordingly, the use of DRX can provide power savings at the UE 115. At a beginning of each DRX cycle, the UE 115 typically wakes up again and repeats the process.

While in the idle mode, the UE 115 may perform signal measurements and cell search. During the search phase, the UE 115 may blindly search for new cells during the SMTC window. During the measurement phase, the UE 115 may be unable to identify new cells, but may measure RSRP, RSRQ, and/or SINR for all detected cells. For example, the UE 115 may search for SSBs during the SMTC window and measure the SSBs, which may include transmissions from a serving SSB and/or one or more non-serving SSBs. While the UE 115 is in idle mode, the SSB with the highest quality RSRP may be referred to as the serving SSB. Other SSBs may be referred to as non-serving SSBs or neighbor SSBs. Additionally or alternatively, a cell that transmitted the serving SSB may be referred to as the serving cell. Other cells may be referred to as non-serving cells or neighbor cells. For each SSB, the UE may measure RSRP, RSRQ, and/or SINR on a set of received or detected SSBs.

A UE 115 may select the cell that provides the UE 115 with a SSB having the best signal strength or quality (e.g., highest RSRP, highest RSRQ, or highest SINR) as the serving cell. After selecting the serving cell, the UE may monitor the serving cell and/or neighbor cells. If the UE 115 detects that a neighbor cell has a better signal strength or quality compared to the serving cell (e.g., higher RSRP than the RSRP associated with the serving cell, higher RSRQ than the RSRQ associated with the serving cell, and/or higher SINR than the SINR associated with the serving cell), the UE 115 may trigger a cell reselection procedure and select the neighbor cell as the serving cell. The UE 115 may be more likely to trigger the cell reselection procedure while the UE is mobile. For example, the UE 115 may be at the edge of the serving cell and as such the signal quality or strength of a neighboring cell may be better than that of the serving cell.

The cell reselection procedure may include an intra-frequency search or an inter-frequency search. An intra-frequency search may refer to the UE searching for a target cell that operates in the same operating carrier frequency as a current serving cell. The UE may perform an intra-frequency action (e.g., a search, a measurement, or a tracking loop) on potential target cells that operate in the same carrier frequency as the current serving cell. An inter-frequency search may refer to the UE searching for a target cell that operates in a different operating carrier frequency as a current serving cell. The UE may perform an inter-frequency action (e.g., a search, a measurement, or a tracking loop) on potential target cells that operate in a different carrier frequency as the current serving cell.

The UE 115 compares the signal qualities of the serving and neighboring cells by performing SSB measurements. The UE 115 may receive a SSB from a cell and may determine a measurement for the SSB, such determinations generally relating to power, signal quality, or signal strength (e.g., RSRPs and/or RSRQs) associated with a received SSB. The signal measurements of the SSB may represent the channel condition in which the SSB is received. The UE 115 may determine, based on a condition of the channel in which the SSB is transmitted, a measurement cycle frequency for performing a SSB measurement. The measurement cycle frequency may specify a frequency with which a task (e.g., SSB measurement) should be performed per X measurement cycles, where X is a positive number. In some aspects, the UE 115 may determine that the channel is in a panic mode if the condition of the channel is poor (e.g., based on low RSRP, RSRQ, and/or SINR). Reference to a channel being in a particular mode may also refer to the UE 115 being in the particular mode or entering the particular mode. The channel condition may be poor due to high mobility of the UE 115, interference, or other factors. For example, a UE may determine that a channel is in the panic mode if the SNR of the channel is less than −6 dB. If the UE 115 determines that the channel is in the panic mode, then the UE 115 may perform intra-frequency or inter-frequency search for cell reselection and enable one or more measurements and/or tracking loops before a paging occasion in each DRX cycle (e.g., in an idle mode of the DRX cycle). Such cell reselection measurements can take a significant amount of time, and not only increase the UE's power consumption as a result but also frustrate the UE's attempt to identify a suitable neighboring cell on which to camp, leading to broken network connectivity. The present disclosure discloses methods, apparatus and systems that facilitate efficient cell reselection by a UE camping in panic mode on a serving cell.

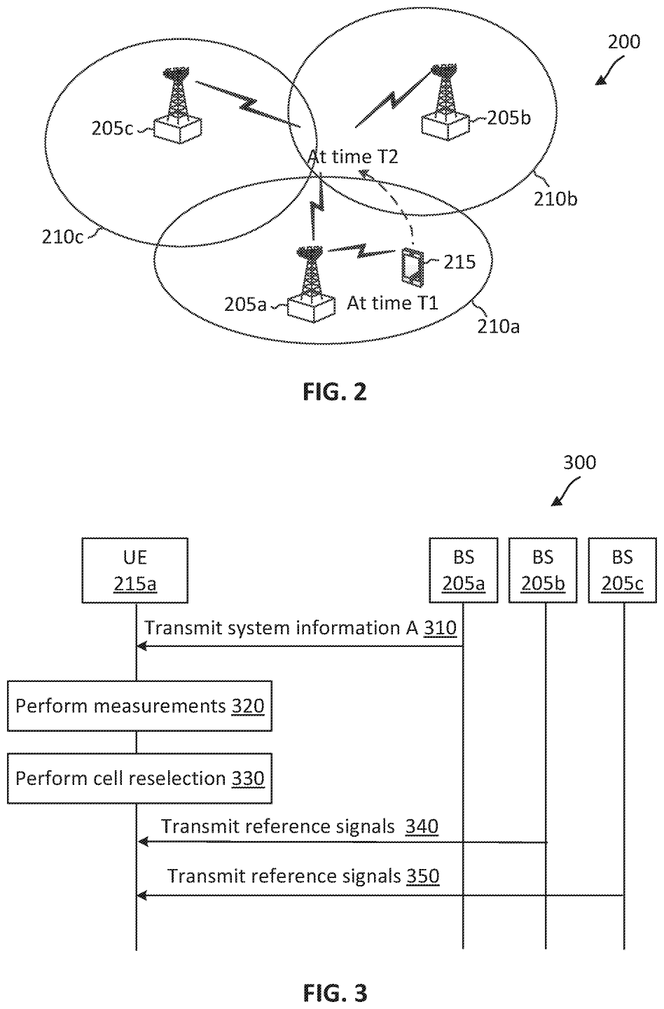

FIGS. 2 and 3 illustrate a cell reselection scenario. FIG. 2 illustrates a wireless communication network 200 according to some aspects of the present disclosure. The network 200 may correspond to a portion of the network 100. FIG. 2 illustrates three BSs 205 (individually labeled as 205a, 205b, and 205c), three cells 210 (individually labeled as 210a, 210b, and 210c), and one UE 215 for purposes of simplicity of discussion, though it will be recognized that aspects of the present disclosure may scale to many more UEs 215 and/or BSs 205. The BSs 205 are similar to the BSs 105. The UE 215 is similar to the UEs 115.

The BS 205a provides service in a coverage area or cell 210a. The BS 205b provides service in a coverage area or cell 210b. The BS 205c provides service in a coverage area or cell 210c. In some examples, the BSs 205a, 205b, and 205c serve the cells 210a, 210b, and 210c, respectively, over different carrier frequencies. In some examples, the BSs 205a, 205b, and 205c serve the cells 210a, 210b, and 210c, respectively, over the same carrier frequency. In some examples, the BSs 205a, 205b, and 205c serve the cells 210a, 210b, and 210c, respectively, using same RATs. In some examples, the BSs 205a, 205b, and 205c serve the cells 210a, 210b, and 210c, respectively, using different RATs (e.g., all may be different RATs or some cells may be served by different RATs while some others may be served using same RAT).

As an example, at time T1, the UE 215 is activated when the UE 215 is in the coverage of the cell 210a. The UE 215 performs an initial cell selection procedure and camp on the cell 210a based channel measurements and certain selection criteria. While camping on the cell 210a, the UE 215 may search for a better cell 210 to camp on, for example, due to mobility of the UE 215 (at time T2) as shown by the dashed arrow to the edge of cell 210a. Mechanisms for performing cell reselection or mobility are described in greater detail herein.

FIG. 3 is a signaling diagram illustrating a cell reselection method 300 according to aspects of the present disclosure. The method 300 is employed by the network 200. The method 300 is implemented by the UE 215 and the BSs 205a, 205b, and 205c. For example, the UE 215 is camped on the cell 210a. Steps of the method 300 can be executed by computing devices (e.g., a processor, processing circuit, and/or other suitable component) of the BS 205a, 205b, and 205c and the UE 215. As illustrated, the method 300 includes a number of enumerated steps, but aspects of the method 300 may include additional steps before, after, and in between the enumerated steps. In some aspects, one or more of the enumerated steps may be omitted or performed in a different order.

At step 310, the BS 205a transmits system information A associated with BS 205a and/or the cell 210a. The BS 205a may transmit the system information A in a broadcast mode periodically to enable a UE desiring to join the network 200 to perform cell selection and initial network access. In addition, the system information A enables a UE camped on the cell 210a to perform channel measurements and/or cell reselection.

The system information A may include SSBs, PSS, SSS, PBCH signals, MIBs, and/or various types of system information blocks (SIBs). For example, a SIB type one (SIB1) provides scheduling information and/or availability of other SIB types and/or information (e.g., public land mobile network (PLMN) information and/or cell barring information) that can guide a UE in performing cell selection. Some examples for the other SIB types may include a SIB type two (SIB2), a SIB type three (SIB3), a SIB type four (SIB4), and a SIB type five (SIB5). A SIB2 provides information for cell reselection that are common for inter-frequency cell reselection, intra-frequency cell reselection, and inter-radio access technology (RAT) cell reselection. For example, a SIB2 may include measurement thresholds for a UE to determine when to start searching for another cell, cell priorities for cell reselection, and/or various cell reselection criteria and/or thresholds. A SIB3 provides neighboring cell related information for intra-frequency cell reselection. For example, the SIB3 includes physical cell identifier (ID) information associated with an intra-frequency neighboring cell and/or corresponding criteria for cell reselection. A SIB4 provides neighboring cell related information for inter-frequency cell reselection. For example, the SIB4 includes physical cell ID, frequency carrier, frequency band, and/or beam information associated with an inter-frequency neighboring cell and/or corresponding criteria for cell reselection. A SIB5 provides neighboring cell related information for inter-RAT cell reselection. For example, the SIB5 includes RAT, frequency carrier, frequency band, and/or beam information associated with an inter-RAT neighboring cell and/or corresponding criteria for cell reselection. An example of an inter-RAT cell reselection may include a UE camped on an NR cell and reselecting to camp on an LTE cell or camping. Alternatively, a UE camped on an LTE cell may reselect to camp on an NR cell. In some instances, an inter-RAT cell reselection may be based on UE's preferences.

In an example, when the cell 210b is an inter-frequency neighboring cell of the cell 210a, the SIB4 may include information to guide a UE 215 to reselect to the cell 210b. Alternatively, when the cell 210b is an intra-frequency neighboring cell of the cell 210a, the SIB3 may include information to guide a UE 215 to reselect to the cell 210b. Yet alternatively, when the cell 210b is an inter-RAT neighboring cell of the cell 210a, the SIB5 may include information to guide a UE 215 to reselect to the cell 210b.

At step 320, while camping on the cell 210a, the UE 215 performs channel measurements. For example, the UE 215 tunes to a channel frequency or carrier frequency of the camped cell 210a, receives a signal from the camped cell 210a on the channel frequency, and measures a received signal quality or a received signal power of the signal (e.g., the periodic system information A) received from the BS 205a. The received signal may be a reference signal associated with the periodic system information A.

In an example, the received signal power may be a reference signal received power (RSRP) and the received signal quality may be a reference signal received quality (RSRQ). A reference signal may refer to a predetermined signal with pilot symbols located at certain frequency subcarriers or resource elements. RSRP is an average signal power of a single reference signal resource element. RSRQ is defined as N×(RSRP/RSSI), where RSSI is an average of total power measured across OFDM symbols that carry a reference signal and N is the number of resource blocks over which RSSI is measured, where each resource block includes a group of consecutive resource elements or subcarriers (e.g., about 12).

At step 330, the UE 215 performs a cell reselection. The UE 215 may autonomously make the cell camping decision. However, the list of cells that are qualified for reselection, the thresholds for beginning a cell search, and/or the cell evaluation parameters and/or the criteria for selecting a candidate cell are configured by the BS 205a through the system information A (e.g., including SIB2, SIB3, SIB4, and/or SIB5).

The UE 215 may start to search for another cell for camping when the measured received signal power and/or the received signal quality from the currently camped cell 210a falls below a certain threshold. In an example, SIB2 can include an s-IntraSearchP threshold, an s-IntraSearchQ threshold, an s-NonIntraSearchP threshold, and/or an s-NonIntraSearchQ threshold for beginning a cell search. When the received signal power of the currently camped cell falls below the s-IntraSearchP threshold and/or when the received signal quality of the currently camped cell falls below the s-IntraSearchQ threshold, the UE 215 may search and/or monitor for an intra-frequency candidate cell. Alternatively, when the received signal power of the currently camped cell falls below the s-NonIntraSearchP threshold and/or when the received signal quality of the currently camped cell falls below the s-NonIntraSearchQ threshold, the UE 215 may optionally search and/or monitor for an inter-frequency candidate cell with an equal or lower reselection priority than a priority of the serving frequency or an inter-RAT candidate cell with an equal or lower cell reselection priority than the serving frequency priority.

During the search, the UE 215 may measure received signal power and/or received signal quality from the currently camped cell 210a and candidate cells (e.g., the cells 210b and 210c). For example, at step 340, the BS 205b transmits reference signals at certain intervals to facilitate signal measurements for cell selection and/or cell reselection. Similarly, at step 350, the BS 205c transmits reference signal at certain intervals to facilitate signal measurements for cell selection and/or cell reselection. The UE 215 may identify the candidate cells based on the signal measurements. For intra-frequency cell reselection, the UE 215 may identify an intra-frequency neighboring cell as a candidate when the intra-frequency neighboring cell has a received signal strength better than the currently camped cell 210a by a certain amount (e.g., based on hysteresis and/or a ranking parameter). When the received signal strength (e.g., the received signal power and/or the received signal quality) of a candidate cell remains better than the currently camped cell 210a by the certain amount for a reference time duration, the UE 215 selects to camp on the candidate cell. In an example, SIB2 can include a t-Reselection (e.g., Treseiection) timer parameter specifying the reference time duration and a Qhyst parameter for the determining that a candidate cell has a better received signal strength than the currently camped cell. SIB3 can include Qoffset parameters for ranking intra-frequency cells. The UE 215 may configure an evaluation duration for the timer based on a reference duration (e.g., t-Reselection time parameter) configured by the system information A. While the timer is running, the UE 215 may continue to monitor and/or evaluate signal measurements of the candidate cell. When the UE 215 detects that a signal measurement of the candidate cell falls below a threshold, the UE 215 stops the timer and aborts the evaluation for the candidate cell. Otherwise, when the timer expires, the UE 215 may select the candidate cell for camping.

For inter-frequency cell reselection and/or inter-RAT cell reselection, the UE 215 may select to camp on a cell with a higher reselection priority than the currently camped cell. The UE 215 may identify an inter-frequency neighboring cell or an inter-RAT neighboring cell as a candidate when the inter-frequency neighboring cell or the inter-RAT neighboring cell has a received signal strength satisfying a threshold. When the received signal strength (e.g., the received signal power and/or the received signal quality) of a candidate cell satisfy a threshold for a reference time duration, the UE 215 selects to camp on the candidate cell. In an example, SIB4 can include a set of cell reselection parameters for each carrier frequency. The set of cell reselection parameters can include a threshX-LowQ threshold, a threshX-LowP threshold, a threshX-HighQ threshold, and/or a threshX-HighP threshold for triggering a new inter-frequency cell to be reselected, a t-Reselection timer parameter for the reference time duration, and/or a cell reselection priority (e.g., an absolute priority) for a corresponding carrier frequency. In an example, SIB5 can include a set of cell reselection parameters for each RAT (e.g., NR or LTE). The set of cell reselection parameters can include a threshX-LowQ threshold, a threshX-Low threshold, a threshX-HighQ threshold, and/or a threshX-High threshold for triggering a new inter-RAT cell to be reselected, a QHyst parameter for the hysteresis, a t-Reselection timer parameter for the reference time duration, and/or a cell reselection priority (e.g., an absolute priority) for a corresponding RAT. In an example, when the UE 215 identifies a candidate cell for cell reselection evaluation, the UE 215 may start a cell reselection timer. The UE 215 may configure an evaluation duration for the timer based on a reference duration (e.g., t-Reselection time parameter) configured by the system information A. While the timer is running, the UE 215 may continue to monitor and/or evaluate signal measurements of the candidate cell. When the UE 215 detects that a signal measurement of the candidate cell falls below a threshold, the UE 215 stops the timer and aborts the evaluation for the candidate cell. Otherwise, when the timer expires, the UE 215 may select the candidate cell for camping.

In some examples, the cell reselection parameters can be arranged in SIB2, SIB3, SIB4, and/or SIB5 as described in the 3GPP document TS 38.331 Release 15, titled “3^{rd} Generation Partnership Project; Technical Specification Group Radio Access Network; NR; Radio Resource Control (RRC) protocol specification,” Sep. 26, 2018, which is incorporated herein by reference in its entirety. In general, the cell reselection parameters can be organized in any suitable arrangement and/or format for system information broadcast.

The above-noted signal measurements by the UE 215 to identify a candidate intra-frequency neighboring cell or inter-frequency neighboring cell on which to camp may be based on the configured value of the nrofSS-BlocksToAverage parameter in SIB2 and SIB4, respectively, that indicate the number of beams of the neighboring cells to be measured as part of the cell reselection determination. That is, the UE 215 measures as many of the beams in the neighboring cells as specified by the configured value of nrofSS-BlocksToAverage in determining that the neighboring cells have signal strength satisfying associated threshold. For example, to identify a candidate intra-frequency neighboring cell, the UE 215 measures the received signal power of as many beams of the intra-frequency neighboring cell as specified by the configured value of the nrofSS-BlocksToAverage parameter in SIB2 and calculates the linear average value of these measurements to determine the received signal power or quality of the intra-frequency neighboring cell. To identify a candidate inter-frequency neighboring cell, the UE 215 measures the received signal power of as many beams of the inter-frequency neighboring cell as specified by the configured value of the nrofSS-BlocksToAverage parameter in SIB4 and calculates the linear average value of these measurements to determine the received signal power or quality of the inter-frequency neighboring cell. In some cases, nrofSS-BlocksToAverage may not be configured (in SIB2 and/or SIB4), in which case the UE 215 may measure the received signal power of all the beams and calculate the linear average value of these measurements to determine the received signal power or quality of the intra- or inter-frequency neighboring cell.

When the UE 215 is in a panic mode, however, measuring the received signal power of as many beams of the neighboring cell as specified by the configured value of the nrofSS-BlocksToAverage parameter (or measuring the received signal power of all the beams of the neighboring cell if the nrofSS-BlocksToAverage parameter is not configured) may not be desirable as the measurements may take significant amount of time, possibly resulting in broken network connectivity for, as well as increased power consumption by, the UE 215. That is, when a UE 215 is camped in panic mode on a serving cell and is attempting to reselect an intra- or inter-neighboring cell for cell reselection due to poor signal quality of the serving cell, improving the neighboring cell signal quality measurements by the UE 215 (e.g., to reduce the amount of time as well as power the UE 215 spends on measuring the signal quality of beams in the intra- or inter-neighboring cell) may be beneficial for network connectivity and UE power and mobility performance. Accordingly, the present disclosure discloses methods, apparatus and systems that facilitate efficient cell reselection by a UE camping in panic mode on a serving cell.

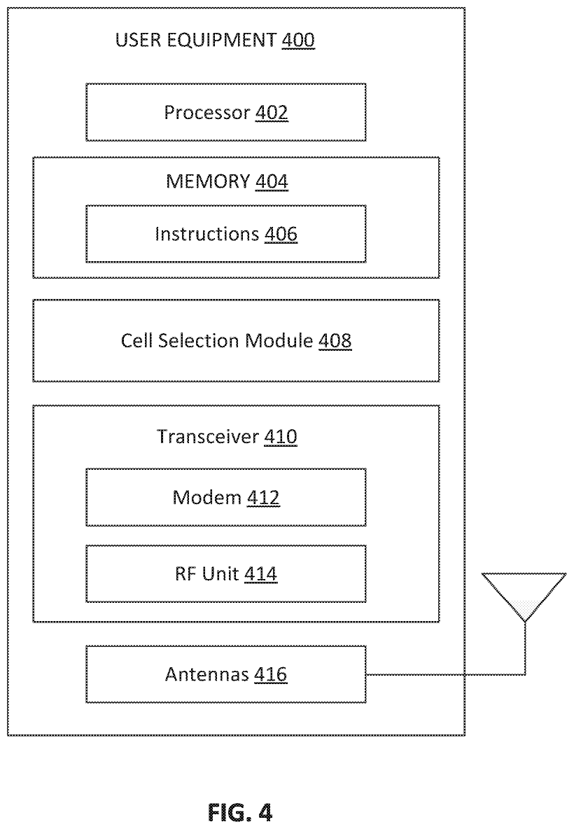

FIG. 4 is a block diagram of an exemplary UE 400 according to aspects of the present disclosure. The UE 400 may be a UE 115 in the network 100 or a UE 215 in the network 200 as discussed above. As shown, the UE 400 may include a processor 402, a memory 404, a cell selection module 408, a transceiver 410 including a modem subsystem 412 and a radio frequency (RF) unit 414, and one or more antennas 416. These elements may be in direct or indirect communication with each other, for example via one or more buses.

The processor 402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

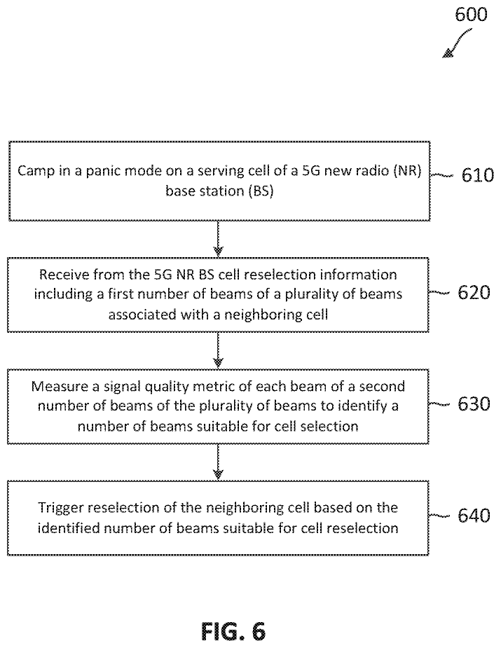

The memory 404 may include a cache memory (e.g., a cache memory of the processor 402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 404 includes a non-transitory computer-readable medium. The memory 404 may store instructions 406. The instructions 406 may include instructions that, when executed by the processor 402, cause the processor 402 to perform the operations described herein with reference to the UEs 115 in connection with aspects of the present disclosure, for example, aspects of FIGS. 6, 7 and 8. Instructions 406 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The cell selection module 408 may be implemented via hardware, software, or combinations thereof. For example, the cell selection module 408 may be implemented as a processor, circuit, and/or instructions 406 stored in the memory 404 and executed by the processor 402. In some examples, the cell selection module 408 can be integrated within the modem subsystem 412. In some examples, the cell selection module 408 may be implemented by a DSP within the modem subsystem 412. The cell selection module 408 may be used for various aspects of the present disclosure, for example, aspects of FIGS. 6, 7, and 8. The cell selection module 408 is configured to select an initial cell (e.g., the cell 110 or 210) for camping, acquire system information (MIB, SIBs, RMSI, OSI) from a BS (e.g., the BS 105 or 205) serving the selected cell, and/or perform cell reselection during an RRC idle mode and/or an RRC inactive mode. The system information may indicate one or more intra-frequency neighboring cells operating over the same carrier frequency as the selected cell, one or more inter-frequency neighboring carrier frequencies and neighboring cells operating over carrier frequencies different from the serving frequency, and/or one or more inter-RAT neighboring cells operating over carrier frequencies different from the serving frequency or on the same carrier frequency as the serving frequency. The system information may indicate a cell reselection priority for the selected cell and each neighboring carrier frequency. The system information may indicate cell reselection criteria (e.g., RSRP threshold, RSRQ threshold, and/or cell reselection evaluation timeout values) for each neighboring frequency and/or neighboring cell.

In an aspect, the cell selection module 408 is configured to monitor and evaluate signal strengths (e.g., RSRPs and RSRQs) of inter-frequency candidate cells and/or inter-RAT candidate cells for cell reselections, determine relative priorities among candidate cells, and/or configure timers and/or adjust timer configurations for evaluating the candidate cells based on the relative priorities to give priority to selection of a highest priority candidate cell. In an aspect, the cell selection module 408 is configured to monitor and evaluate signal strengths (e.g., RSRPs and RSRQs) of intra-frequency candidate cells, configure a timer for evaluating each candidate cell, perform a one-shot signal measurement (e.g., RSRP or RSRQ) for each candidate cell upon an expiration of a cell reselection timer (e.g., corresponding to a cell A), identify a subset of candidate cells having a stronger signal strength than cell A based on the one-shot measurements, and/or select a candidate cell with a strongest signal strength or a signal strength satisfying a signal threshold for a longest duration from the subset for camping. In some aspects, the cell selection module 408 may be configured to regulate the number of beams of an intra- and/or inter-frequency neighboring candidate cell that may be measured as part of a cell reselection process for a UE 400 that is in panic mode. The cell reselection module 408 may also be configured to reset the cell reselection timer to zero once the neighboring cell is selected based on the measurements of the beams. Mechanisms for performing cell reselections while regulating or limiting the number of beams to be measured for the cell reselections are described in greater detail herein.

As shown, the transceiver 410 may include the modem subsystem 412 and the RF unit 414. The transceiver 410 can be configured to communicate bi-directionally with other devices, such as the BSs 105. The modem subsystem 412 may be configured to modulate and/or encode the data from the memory 404, the cell selection module 408 according to a modulation and coding scheme (MCS), e.g., a low-density parity check (LDPC) coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data from the modem subsystem 412 (on outbound transmissions) or of transmissions originating from another source such as a UE 115 or a BS 105. The RF unit 414 may be further configured to perform analog beamforming in conjunction with the digital beamforming. Although shown as integrated together in transceiver 410, the modem subsystem 412 and the RF unit 414 may be separate devices that are coupled together at the UE 115 to enable the UE 115 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices. The antennas 416 may provide the received data messages for processing and/or demodulation at the transceiver 410. The antennas 416 may include multiple antennas of similar or different designs in order to sustain multiple transmission links. The RF unit 414 may configure the antennas 416.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement RATs.

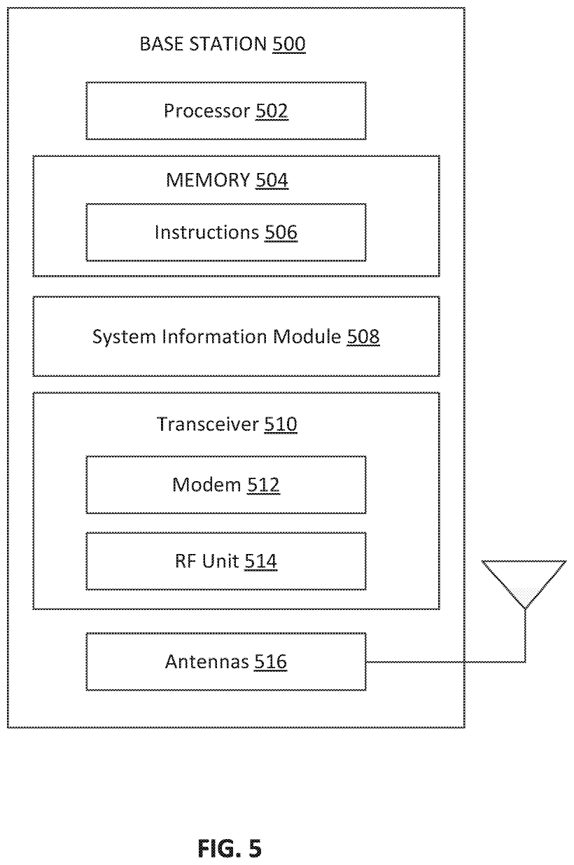

FIG. 5 is a block diagram of an exemplary BS 500 according to aspects of the present disclosure. The BS 500 may be a BS 105 in the network 100 or a BS 205 in the network 200 as discussed above. A shown, the BS 500 may include a processor 502, a memory 504, a system information module 508, a transceiver 510 including a modem subsystem 512 and a RF unit 514, and one or more antennas 516. These elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 6, 7 and 8. Instructions 506 may also be referred to as code, which may be interpreted broadly to include any type of computer-readable statement(s) as discussed above with respect to FIG. 4.

The system information module 508 may be implemented via hardware, software, or combinations thereof. For example, the system information module 508 may be implemented as a processor, circuit, and/or instructions 506 stored in the memory 504 and executed by the processor 502. In some examples, the system information module 508 may be implemented by a DSP within the modem subsystem 512. The system information module 508 may be used for various aspects of the present disclosure, for example, aspects of FIGS. 6, 7 and 8. The system information module 508 is configured to transmit broadcast system information periodically according to certain schedules to enable a UE (e.g., the UEs 115, 215, and 400) to perform initial network access, cell selection, and/or reselection, as described in greater detail herein. The system information may indicate one or more intra-frequency neighboring cells operating over the same carrier frequency as the selected cell, one or more inter-frequency neighboring carrier frequencies and neighboring cells operating over carrier frequencies different from the serving frequency, and/or one or more inter-RAT neighboring cells operating over carrier frequencies different from the serving frequency or on the same carrier frequency as the serving frequency. The system information may indicate a cell reselection priority for the selected cell and each neighboring carrier frequency. The system information may indicate cell reselection criteria (e.g., RSRP threshold, RSRQ threshold, and/or cell reselection evaluation timeout values) for each neighboring frequency and/or neighboring cell.

As shown, the transceiver 510 may include the modem subsystem 512 and the RF unit 514. The transceiver 510 can be configured to communicate bi-directionally with other devices, such as the UEs 115 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data from the modem subsystem 512 (on outbound transmissions) or of transmissions originating from another source such as a UE 115, 215, or 400. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. This may include, for example, transmission of information to complete attachment to a network and communication with a camped UE 115 or 500 according to aspects of the present disclosure. The antennas 516 may further receive data messages transmitted from other devices and provide the received data messages for processing and/or demodulation at the transceiver 510. The antennas 516 may include multiple antennas of similar or different designs in order to sustain multiple transmission links.

In an aspect, the BS 500 can include multiple transceivers 510 implementing different RATs (e.g., NR and LTE). In an aspect, the BS 500 can include a single transceiver 510 implementing multiple RATs (e.g., NR and LTE). In an aspect, the transceiver 510 can include various components, where different combinations of components can implement RATs.

FIG. 6 is a flow diagram of a method 600 of wireless communication according to aspects of the present disclosure. Blocks of the method 600 can be executed by a computing device (e.g., a processor, processing circuit, and/or other suitable component) of a wireless communication device, such as the UE 115. As illustrated, the method 600 includes a number of enumerated blocks, but aspects of the method 600 may include additional blocks before, after, and in between the enumerated block. In some aspects, one or more of the enumerated blocks may be omitted or performed in a different order.

At block 610, the method 600 includes a UE camping on a serving cell of a 5G NR BS that is in a standalone mode. The UE may be in a panic mode, for example, after determining that the serving cell channel conditions are poor and below some serving cell operation criteria.

At block 620, the method 600 includes the UE receiving, from the 5G NR BS, cell reselection information including a first number of beams of a plurality of beams associated with a neighboring cell and configured to be measured for cell reselection of the neighboring cell.

In some aspects, the reselection of the neighboring cell may be an intra-frequency cell reselection, i.e., the cell reselection may refer to a UE searching for a neighboring cell that operates in the same operating carrier frequency as the current serving cell. In such aspects, the cell reselection information can include a SIB2 associated with the neighboring cell having a configured value of nrofSS-BlocksToAverage. In some instances, the first number of beams can be equal to nrofSS-BlocksToAverage, and the second number of beams of the plurality of beams can be different from the configured value of the nrofSS-BlocksToAverage. In yet some instances, the first number of beams can be equal to the total number of beams of the plurality of beams, and the second number of beams of the plurality of beams can be different from the total number of beams.

In some aspects, the reselection of the neighboring cell may be an inter-frequency cell reselection, i.e., the cell reselection may refer to a UE searching for a neighboring cell that operates in a operating carrier frequency different from that of the current serving cell. In such aspects, the cell reselection information can include a SIB4 associated with the neighboring cell having a configured value of nrofSS-BlocksToAverage. In some instances, the first number of beams can be equal to nrofSS-BlocksToAverage, and the second number of beams of the plurality of beams can be different from the configured value of the nrofSS-BlocksToAverage. In yet some instances, the first number of beams can be equal to the total number of beams of the plurality of beams, and the second number of beams of the plurality of beams can be different from the total number of beams.

At block 630, the method 600 includes the UE measuring a signal quality metric of each beam of a second number of beams of the plurality of beams to identify a number of beams suitable for cell reselection, the second number of beams being less than the first number of beams of the plurality of beams. The signal quality metric of a beam may include a reference signal received power (RSRP), a reference signal received quality (RSRQ), a signal-to-noise ratio (SINR), etc., of a beam.

At block 640, the method 600 includes the UE triggering reselection of the neighboring cell based on the identified number of beams suitable for cell reselection. For example, the UE, via its processor, may calculate the linear average value of the signal quality metrices of the second number of beams, and use that measurement value to trigger the reselection of the neighboring cell (e.g., if that average value is higher than similar average value for the serving cell or other cells searched by the UE).

In some aspects, the afore-mentioned cell reselection information of method 600 can include a reselection timer for executing the reselection of the neighboring cell, i.e., cell reselection information may include a timer for setting a duration for the reselection of the neighboring cell once the search for the neighboring cell commences. In such cases, the method 600 may further include resetting the timer to zero after the reselection of the neighboring cell is triggered.

By executing method 600, in some aspects, a UE may measure less number of beams of a candidate neighboring cell than specified by the cell reselection information provided by a NR BS (e.g., less number of beams than nrofSS-BlocksToAverage specified in SIB2 for intra-frequency cell reselection and in SIB4 for inter-frequency cell reselection, or total number of beams if nrofSS-BlocksToAverage is not configured). In cases where nrofSS-BlocksToAverage is not configured, the execution of method 600 allows a UE to measure less than all the beams in the candidate neighboring cell. As such, the execution of method 600 by a UE allows the UE to identify a candidate neighboring cell for cell reselection quickly and with limited power consumption; in other words, more efficiently, as compared to a cell reselection process undertaken without the execution of method 600.

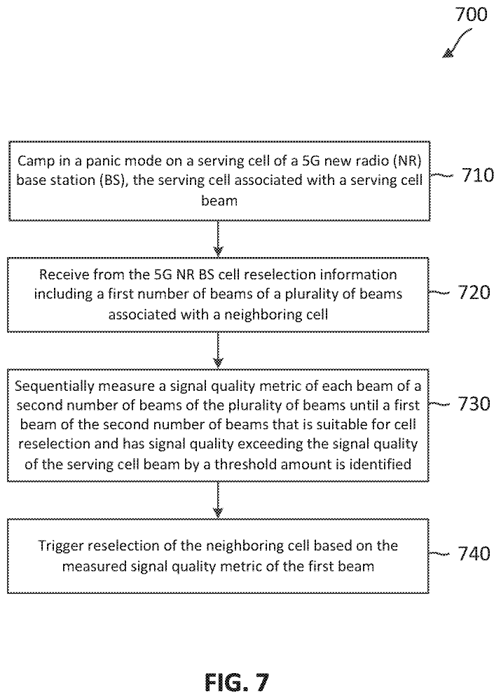

FIG. 7 is a flow diagram of a method 700 of wireless communication according to aspects of the present disclosure. Blocks of the method 700 can be executed by a computing device (e.g., a processor, processing circuit, and/or other suitable component) of a wireless communication device, such as the UE 115. As illustrated, the method 700 includes a number of enumerated blocks, but aspects of the method 700 may include additional blocks before, after, and in between the enumerated block. In some aspects, one or more of the enumerated blocks may be omitted or performed in a different order.

At block 710, the method 700 includes a UE camping on a serving cell of a 5G NR BS that is in a standalone mode. The UE may be in a panic mode, for example, after determining that the serving cell channel conditions are poor and below some serving cell operation criteria. The serving cell may have an associated serving cell beam.

At block 720, the method 700 includes the UE receiving, from the 5G NR BS, cell reselection information including a first number of beams of a plurality of beams associated with a neighboring cell and configured to be measured for cell reselection of the neighboring cell.

In some aspects, the reselection of the neighboring cell may be an intra-frequency cell reselection, i.e., the cell reselection may refer to a UE searching for a neighboring cell that operates in the same operating carrier frequency as the current serving cell. In such aspects, the cell reselection information can include a SIB2 associated with the neighboring cell having a configured value of nrofSS-BlocksToAverage. In some instances, the first number of beams can be equal to nrofSS-BlocksToAverage, and the second number of beams of the plurality of beams is less than the configured value of the nrofSS-BlocksToAverage. In yet some instances, the first number of beams can be equal to the total number of beams of the plurality of beams, and the second number of beams of the plurality of beams is less than the total number of beams of the plurality of beams.

In some aspects, the reselection of the neighboring cell may be an inter-frequency cell reselection, i.e., the cell reselection may refer to a UE searching for a neighboring cell that operates in a operating carrier frequency different from that of the current serving cell. In such aspects, the cell reselection information can include a SIB4 associated with the neighboring cell having a configured value of nrofSS-BlocksToAverage. In some instances, the first number of beams can be equal to nrofSS-BlocksToAverage, and the second number of beams of the plurality of beams is less than the configured value of the nrofSS-BlocksToAverage. In yet some instances, the first number of beams can be equal to the total number of beams of the plurality of beams, and the second number of beams of the plurality of beams is less than the total number of beams of the plurality of beams.

At block 730, the method 700 includes the UE sequentially measuring a signal quality metric of each beam of a second number of beams of the plurality of beams until a first beam of the second number of beams that is suitable for cell reselection is identified. In some aspects, a signal quality metric of the first beam can exceed a signal quality metric of the serving cell beam by a threshold amount. In addition, the second number of beams can be less than the first number of beams of the plurality of beams. The signal quality metric of a beam may include a reference signal received power (RSRP), a reference signal received quality (RSRQ), a signal-to-noise ratio (SINR), etc., of a beam.

In some aspects, the threshold amount is an amount of the signal quality metric chosen so as to prevent the ping-pong effect where the UE may bounce (e.g., via handover) from one cell or BS to another in search of an ever higher signal quality. For example, the threshold amount can be such that once the UE shifts from the serving cell and camps on a selected neighboring cell, the UE stays camped on the neighboring cell at least for some duration (e.g., 5 seconds, 10 seconds, 15 seconds, 30 seconds, 1 minute, etc., including values and subranges therein).

At block 740, the method 700 includes the UE triggering reselection of the neighboring cell based on the measured signal quality metric of the first beam.

In some aspects, the afore-mentioned cell reselection information of method 700 can include a reselection timer for executing the reselection of the neighboring cell, i.e., cell reselection information may include a timer for setting a duration for the reselection of the neighboring cell once the search for the neighboring cell commences. In such cases, the method 700 may further include resetting the timer to zero after the reselection of the neighboring cell is triggered.

Method 700 can be illustrated with reference to FIG. 9, which is a schematic graph diagram illustrating a cell reselection method according to some aspects of the present disclosure. The graph 900 shows beam power levels for six beams 905, 910, 915, 920, 925 and 930 of a neighboring cell that is a candidate for cell reselection (nrofSS-BlocksToAverage=6 in SIB2 for intra-frequency neighboring cell search and in SIB4 for inter-frequency neighboring cell search, or total number of beams=6 if nrofSS-BlocksToAverage is not configured) from a serving cell on which a UE is camped. The serving cell has an associated serving cell beam power level 935, and a power level measurement of a beam can be used for cell reselection determination if the power level measurement exceeds the serving cell beam power level 935 at least by a threshold beam power amount 940, that is, the power level measurement of the beam has to exceed the minimum power level measurement 945. Upon receiving the cell reselection information indicating six beams in the neighboring cell (i.e., the cell reselection information SIB2 or SIB4 having nrofSS-BlocksToAverage=6), the UE may measure the beam power level of the first beam 905. Even though the first beam 905 has a beam power level exceeding the serving cell beam power level 935, the first beam's power level fail to exceed the minimum power level measurement 945, and as such the beam power level of the first beam 905 is not used for cell reselection determinations. The UE may then proceed to measure the beam power level of the next beam, the second beam 910, and discover that the beam power level of the second beam exceeds the minimum power level measurement 945.

Upon identifying a beam with a beam power level exceeding the minimum power level measurement 945, the UE does not measure beam power levels of the rest of the beams 915, 920, 925 and 930 of the neighboring cell, and instead uses the measured beam power level of the second beam 910 to trigger cell reselection of the neighboring cell. In other words, by executing method 700, the UE measures four less beams than would have been the case otherwise when performing cell reselection determination of the neighboring cell. As such, in some respects, method 700 allows a UE to measure less number of beams of a candidate neighboring cell than specified by the cell reselection information provided by a NR BS (e.g., less number of beams than nrofSS-BlocksToAverage specified in SIB2 for intra-frequency cell reselection and in SIB4 for inter-frequency cell reselection or total number of beams if nrofSS-BlocksToAverage is not configured). Accordingly, the execution of method 700 by a UE allows the UE to identify a candidate neighboring cell for cell reselection quickly and with limited power consumption; in other words, more efficiently, as compared to a cell reselection process undertaken without the execution of method 700.

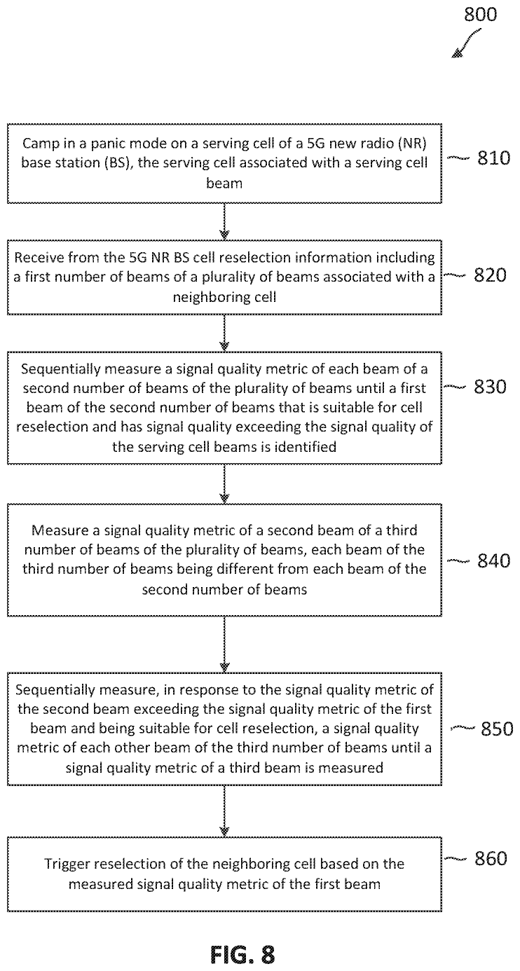

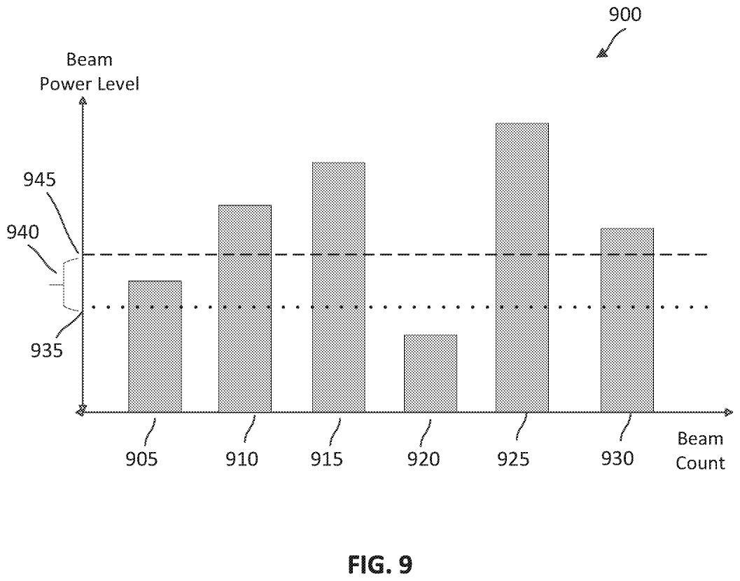

FIG. 8 is a flow diagram of a method 800 of wireless communication according to aspects of the present disclosure. Blocks of the method 800 can be executed by a computing device (e.g., a processor, processing circuit, and/or other suitable component) of a wireless communication device, such as the UE 115. As illustrated, the method 800 includes a number of enumerated blocks, but aspects of the method 800 may include additional blocks before, after, and in between the enumerated block. In some aspects, one or more of the enumerated blocks may be omitted or performed in a different order.

At block 810, the method 800 includes a UE camping on a serving cell of a 5G NR BS that is in a standalone mode. The UE may be in a panic mode, for example, after determining that the serving cell channel conditions are poor and below some serving cell operation criteria. The serving cell may have an associated serving cell beam.

At block 820, the method 800 includes the UE receiving, from the 5G NR BS, cell reselection information including a first number of beams of a plurality of beams associated with a neighboring cell and configured to be measured for cell reselection of the neighboring cell.

In some aspects, the reselection of the neighboring cell may be an intra-frequency cell reselection, i.e., the cell reselection may refer to a UE searching for a neighboring cell that operates in the same operating carrier frequency as the current serving cell. In such aspects, the cell reselection information can include a SIB2 associated with the neighboring cell having a configured value of nrofSS-BlocksToAverage. In some instances, the first number of beams can be equal to nrofSS-BlocksToAverage, and the sum of the second number of beams and the third number of beams is less than the configured value of the nrofSS-BlocksToAverage. In yet some instances, the first number of beams can be equal to the total number of beams of the plurality of beams, and the sum of the second number of beams and the third number of beams is less than the total number of beams.

In some aspects, the reselection of the neighboring cell may be an inter-frequency cell reselection, i.e., the cell reselection may refer to a UE searching for a neighboring cell that operates in a operating carrier frequency different from that of the current serving cell. In such aspects, the cell reselection information can include a SIB4 associated with the neighboring cell having a configured value of nrofSS-BlocksToAverage. In some instances, the first number of beams can be equal to nrofSS-BlocksToAverage, and the sum of the second number of beams and the third number of beams is less than the configured value of the nrofSS-BlocksToAverage. In yet some instances, the first number of beams can be equal to the total number of beams of the plurality of beams, and the sum of the second number of beams and the third number of beams is less than the total number of beams of the plurality of beams.

At block 830, the method 800 includes the UE sequentially measuring a signal quality metric of each beam of a second number of beams of the plurality of beams until a first beam of the second number of beams that is suitable for cell reselection is identified. In some aspects, a signal quality metric of the first beam can exceed a signal quality metric of the serving cell beam by a threshold amount. The signal quality metric of a beam may include a reference signal received power (RSRP), a reference signal received quality (RSRQ), a signal-to-noise ratio (SINR), etc., of a beam.

In some aspects, the threshold amount is an amount of the signal quality metric chosen so as to prevent the ping-pong effect where the UE may bounce (e.g., via handover) from one cell or BS to another in search of an ever higher signal quality. For example, the threshold amount can be such that once the UE shifts from the serving cell and camps on a selected neighboring cell, the UE stays camped on the neighboring cell at least for some duration (e.g., 5 seconds, 10 seconds, 15 seconds, 30 seconds, 1 minute, etc., including values and subranges therein).

At block 840, the method 800 includes the UE triggering reselection of the neighboring cell based on the measured signal quality metric of the first beam and the measured signal quality metric of each of the second number of beams excluding the third beam.

In some aspects, the afore-mentioned cell reselection information of method 800 can include a reselection timer for executing the reselection of the neighboring cell, i.e., cell reselection information may include a timer for setting a duration for the reselection of the neighboring cell once the search for the neighboring cell commences. In such cases, the method 800 may further include resetting the timer to zero after the reselection of the neighboring cell is triggered.

Method 800 can be illustrated with reference to FIG. 9, which is a schematic graph diagram illustrating a cell reselection method according to some aspects of the present disclosure. The graph 900 shows beam power levels for six beams 905, 910, 915, 920, 925 and 930 of a neighboring cell that is a candidate for cell reselection (nrofSS-BlocksToAverage=6 in SIB2 for intra-frequency neighboring cell search and in SIB4 for inter-frequency neighboring cell search, or total number of beams=6 if nrofSS-BlocksToAverage is not configured) from a serving cell on which a UE is camped. The serving cell has an associated serving cell beam power level 935, and a power level measurement of a beam can be used for cell reselection determination if the power level measurement exceeds the serving cell beam power level 935 at least by a threshold beam power amount 940, that is, the power level measurement of the beam has to exceed the minimum power level measurement 945. Upon receiving the cell reselection information indicating six beams in the neighboring cell (i.e., the cell reselection information SIB2 or SIB4 having nrofSS-BlocksToAverage=6), the UE may measure the beam power level of the first beam 905. Even though the first beam 905 has a beam power level exceeding the serving cell beam power level 935, the first beam's power level fail to exceed the minimum power level measurement 945, and as such the beam power level of the first beam 905 is not used for cell reselection determinations. The UE may then proceed to measure the beam power level of the next beam, the second beam 910, and discover that the beam power level of the second beam exceeds the minimum power level measurement 945.

Upon identifying a beam with a beam power level exceeding the minimum power level measurement 945, the UE proceeds with measuring the beam power levels of the rest of the beams 915, 920, 925 and 930 of the neighboring cell until a beam power level is measured that has less beam power than the immediately preceding beam. For example, after identifying the second beam 910 as the first beam with a beam power level exceeding the minimum power level measurement 945, the UE may proceed with measuring the beam power level of the next (third) beam 915. Since the third beam 915 has beam power level that exceeds the beam power level of the immediately preceding beam, the second beam 910, the UE may proceed with measuring the beam power level of the next beam, the fourth beam 920. The fourth beam 92 has a beam power level that is less than the beam power level of the immediately preceding beam, the third beam 915, and as such, the UE may not proceeding with measuring the beam power levels of any of the rest of the beams, i.e., beams 925 and 930. The UE then uses the measured beam power levels of the beams that exceed the minimum power level measurement 945 (i.e., the measured beam power levels of beams 910 and 915 (and excluding that of beam 920)) to trigger cell reselection of the neighboring cell.

In other words, by executing method 800, the UE measures two less beams than would have been the case otherwise when performing cell reselection determination of the neighboring cell. As such, in some respects, method 800 allows a UE to measure less number of beams of a candidate neighboring cell than specified by the cell reselection information provided by a NR BS (e.g., less number of beams than nrofSS-BlocksToAverage specified in SIB2 for intra-frequency cell reselection and in SIB4 for inter-frequency cell reselection or total number of beams if nrofSS-BlocksToAverage is not configured). Accordingly, the execution of method 800 by a UE allows the UE to identify a candidate neighboring cell for cell reselection quickly and with limited power consumption; in other words, more efficiently, as compared to a cell reselection process undertaken without the execution of method 800.

### RECITATIONS OF SOME ASPECTS OF THE DISCLOSURE

Aspect 1: A method of wireless communication performed by a user equipment (UE), the method comprising: camping in a panic mode on a serving cell of a 5G new radio (NR) base station (BS); receiving from the 5G NR BS cell reselection information including a first number of beams of a plurality of beams associated with a neighboring cell and configured to be measured for cell reselection of the neighboring cell; measuring a signal quality metric of each beam of a second number of beams of the plurality of beams to identify a number of beams suitable for cell reselection, the second number of beams being less than the first number of beams of the plurality of beams; and triggering reselection of the neighboring cell based on the identified number of beams suitable for cell reselection.

Aspect 2: The method of aspect 1, wherein the reselection of the neighboring cell is an intra-frequency cell reselection.

Aspect 3: The method of aspect 1 or 2, wherein: the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and the second number of beams of the plurality of beams is different from the configured value of the nrofSS-BlocksToAverage.

Aspect 4: The method of any of aspects 1-3, wherein: the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and the second number of beams of the plurality of beams is different from the total number of beams.

Aspect 5: The method of aspect 1, wherein the reselection of the neighboring cell is an inter-frequency cell reselection.

Aspect 6: The method of aspect 1 or 5, wherein: the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and the second number of beams of the plurality of beams is different from the configured value of the nrofSS-BlocksToAverage.

Aspect 7: The method of any of aspects 1 or 6, wherein: the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and the second number of beams of the plurality of beams is different from the total number of beams of the plurality of beams.

Aspect 8: The method of any of aspects 1-7, wherein the cell reselection information includes a reselection timer for executing the reselection of the neighboring cell, the method further comprising: resetting the reselection timer to zero after the reselection of the neighboring cell is triggered.

Aspect 9: The method of any of aspects 1-8, wherein the UE is configured to operate in a new radio (NR) standalone mode.

Aspect 10: A method of wireless communication performed by a user equipment (UE), the method comprising: camping in a panic mode on a serving cell of a 5G new radio (NR) base station (BS), the serving cell associated with a serving cell beam; receiving from the 5G NR BS cell reselection information including a first number of beams of a plurality of beams associated with a neighboring cell and configured to be measured for cell reselection of the neighboring cell; sequentially measuring a signal quality metric of each beam of a second number of beams of the plurality of beams until a first beam of the second number of beams that is suitable for cell reselection is identified, a signal quality metric of the first beam exceeding a signal quality metric of the serving cell beam by a threshold amount, and the second number of beams being less than the first number of beams of the plurality of beams; and triggering reselection of the neighboring cell based on the measured signal quality metric of the first beam.

Aspect 11: The method of aspect 10, further comprising: camping on the neighboring cell in response to the reselection of the neighboring cell, wherein the threshold amount is configured to prevent the UE from entering panic mode within a duration of camping on the neighboring cell.

Aspect 12: The method of aspect 11, wherein the duration is 10 seconds.

Aspect 13: The method of any of aspects 10-12, wherein the reselection of the neighboring cell is an intra-frequency cell reselection.

Aspect 14: The method of any of aspects 10-13, wherein: the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and the second number of beams of the plurality of beams is less than the configured value of the nrofSS-BlocksToAverage.

Aspect 15: The method of any of aspects 10-13, wherein: the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and the second number of beams of the plurality of beams is less than the total number of beams of the plurality of beams.

Aspect 16: The method of any of aspects 10-12, wherein the reselection of the neighboring cell is an inter-frequency cell reselection.

Aspect 17: The method of any of aspects 10, 11, 12, and 16, wherein: the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and the second number of beams of the plurality of beams is less than the configured value of the nrofSS-BlocksToAverage.

Aspect 18: The method of any of aspects 10, 11, 12, and 16, wherein the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and the second number of beams of the plurality of beams is less than the total number of beams of the plurality of beams.

Aspect 19: The method of any of aspects 10-18, wherein the cell reselection information includes a reselection timer for executing the reselection of the neighboring cell, the method further comprising: resetting the reselection timer to zero after the reselection of the neighboring cell is triggered.

Aspect 20: The method of any of aspects 10-19, wherein the UE is configured to operate in a new radio (NR) standalone mode.

Aspect 21: A method of wireless communication performed by a user equipment (UE), the method comprising: camping in a panic mode on a serving cell of a 5G new radio (NR) base station (BS), the serving cell associated with a serving cell beam; receiving from the 5G NR BS cell reselection information including a first number of beams of a plurality of beams associated with a neighboring cell and configured to be measured for cell reselection of the neighboring cell; sequentially measuring a signal quality metric of each beam of a second number of beams of the plurality of beams until a first beam of the second number of beams that is suitable for cell reselection is identified, a signal quality metric of the first beam exceeding a signal quality metric of the serving cell beam by a threshold amount; measuring a signal quality metric of a second beam of a third number of beams of the plurality of beams, each beam of the third number of beams being different from each beam of the second number of beams; sequentially measuring, in response to the signal quality metric of the second beam exceeding the signal quality metric of the first beam and being suitable for cell reselection, a signal quality metric of each other beam of the third number of beams until a signal quality metric of a third beam is measured, the signal quality metric of the third beam being less than the signal quality metric of the beam in the third number beams measured immediately prior to the measurement of the signal quality metric of the third beam; and triggering reselection of the neighboring cell based on the measured signal quality metric of the first beam and the measured signal quality metric of each of the second number of beams excluding the third beam.

Aspect 22: The method of aspect 21, further comprising: camping on the neighboring cell in response to the reselection of the neighboring cell, wherein the threshold amount is configured to prevent the UE from entering panic mode within a duration of camping on the neighboring cell.

Aspect 23: The method of aspect 21 or 22, wherein the duration is 10 seconds.

Aspect 24: The method of any of aspects 21-23, wherein the reselection of the neighboring cell is an intra-frequency cell reselection.

Aspect 25: The method of any of aspects 21-24, wherein: the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and a sum of the second number of beams and the third number of beams is less than the configured value of the nrofSS-BlocksToAverage.

Aspect 26: The method of any of aspects 21-24, wherein: the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and a sum of the second number of beams and the third number of beams is less than the total number of beams.

Aspect 27: The method of any of aspects 21-23, wherein the reselection of the neighboring cell is an inter-frequency cell reselection.

Aspect 28: The method of any of aspects 21, 22, 23, and 27, wherein: the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and a sum of the second number of beams and the third number of beams is less than the configured value of the nrofSS-BlocksToAverage.

Aspect 29: The method of any of aspects 21, 22, 23, and 27, wherein: the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and a sum of the second number of beams and the third number of beams is less than the total number of beams of the plurality of beams.

Aspect 30: The method of any of aspects 21-29, wherein the cell reselection information includes a reselection timer for executing the reselection of the neighboring cell, the method further comprising: resetting the reselection timer to zero after the reselection of the neighboring cell is triggered.

Aspect 31: The method of any of aspects 21-30, wherein the UE is configured to operate in a new radio (NR) standalone mode.

Aspect 32: A user equipment (UE) comprising means for performing the methods of aspects 1-9.

Aspect 33: A user equipment (UE) comprising means for performing the methods of aspects 10-20.

Aspect 34: A user equipment (UE) comprising means for performing the methods of aspects 21-31.

Aspect 35: A non-transitory computer-readable medium (CRM) having program code recorded thereon, the program code comprises code for causing a UE to perform the methods of aspects 1-9.

Aspect 36: A non-transitory computer-readable medium (CRM) having program code recorded thereon, the program code comprises code for causing a UE to perform the methods of aspects 10-20.

Aspect 37: A non-transitory computer-readable medium (CRM) having program code recorded thereon, the program code comprises code for causing a UE to perform the methods of aspects 21-31.

Aspect 38: A user equipment (UE), comprising: a memory; a processor coupled to the memory; and a transceiver coupled to the processor, and configured to perform the methods of aspects 1-9.

Aspect 39: A user equipment (UE), comprising: a memory; a processor coupled to the memory; and a transceiver coupled to the processor, and configured to perform the methods of aspects 10-20.

Aspect 40: A user equipment (UE), comprising: a memory; a processor coupled to the memory; and a transceiver coupled to the processor, and configured to perform the methods of aspects 21-31.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
camping in a panic mode on a serving cell of a 5G new radio (NR) base station (BS);
receiving from the 5G NR BS cell reselection information including a first number of beams of a plurality of beams associated with a neighboring cell and configured to be measured for cell reselection of the neighboring cell;
measuring a signal quality metric of each beam of a second number of beams of the plurality of beams to identify a number of beams suitable for cell reselection, the second number of beams being less than the first number of beams of the plurality of beams; and
triggering reselection of the neighboring cell based on the identified number of beams suitable for cell reselection.

2. The method of claim 1, wherein the reselection of the neighboring cell is an intra-frequency cell reselection.

3. The method of claim 2, wherein:
the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is different from the configured value of the nrofSS-BlocksToAverage.

4. The method of claim 2, wherein:
the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is different from the total number of beams.

5. The method of claim 1, wherein the reselection of the neighboring cell is an inter-frequency cell reselection.

6. The method of claim 5, wherein:
the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is different from the configured value of the nrofSS-BlocksToAverage.

7. The method of claim 5, wherein:
the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is different from the total number of beams of the plurality of beams.

8. The method of claim 1, wherein the cell reselection information includes a reselection timer for executing the reselection of the neighboring cell, the method further comprising:
resetting the reselection timer to zero after the reselection of the neighboring cell is triggered.

9. A method of wireless communication performed by a user equipment (UE), the method comprising:
camping in a panic mode on a serving cell of a 5G new radio (NR) base station (BS), the serving cell associated with a serving cell beam;
receiving from the 5G NR BS cell reselection information including a first number of beams of a plurality of beams associated with a neighboring cell and configured to be measured for cell reselection of the neighboring cell;
sequentially measuring a signal quality metric of each beam of a second number of beams of the plurality of beams until a first beam of the second number of beams that is suitable for cell reselection is identified,
a signal quality metric of the first beam exceeding a signal quality metric of the serving cell beam by a threshold amount, and
the second number of beams being less than the first number of beams of the plurality of beams; and
triggering reselection of the neighboring cell based on the measured signal quality metric of the first beam.

10. The method of claim 9, further comprising:
camping on the neighboring cell in response to the reselection of the neighboring cell, wherein the threshold amount is configured to prevent the UE from entering panic mode within a duration of camping on the neighboring cell.

11. The method of claim 9, wherein the reselection of the neighboring cell is an intra-frequency cell reselection.

12. The method of claim 11, wherein:
the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is less than the configured value of the nrofSS-BlocksToAverage.

13. The method of claim 11, wherein:
the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is less than the total number of beams of the plurality of beams.

14. The method of claim 9, wherein the reselection of the neighboring cell is an inter-frequency cell reselection.

15. The method of claim 14, wherein:
the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is less than the configured value of the nrofSS-BlocksToAverage.

16. The method of claim 14, wherein:
the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is less than the total number of beams of the plurality of beams.

17. The method of claim 9, wherein the cell reselection information includes a reselection timer for executing the reselection of the neighboring cell, the method further comprising:
resetting the reselection timer to zero after the reselection of the neighboring cell is triggered.

18. A user equipment (UE), comprising:
a transceiver configured to receive, 5G new radio (NR) base station (BS), cell reselection information including a first number of beams of a plurality of beams associated with a neighboring cell and configured to be measured for cell reselection of the neighboring cell; and
a processor configured to:
camp in a panic mode on a serving cell of the 5G NR BS;
measure a signal quality metric of each beam of a second number of beams of the plurality of beams to identify a number of beams suitable for cell reselection, the second number of beams being less than the first number of beams of the plurality of beams; and
trigger reselection of the neighboring cell based on the identified number of beams suitable for cell reselection.

19. The UE of claim 18, wherein the reselection of the neighboring cell is an intra-frequency cell reselection.

20. The UE of claim 19, wherein:
the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is different from the configured value of the nrofSS-BlocksToAverage.

21. The UE of claim 19, wherein:
the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is different from the total number of beams.

22. The UE of claim 18, wherein the reselection of the neighboring cell is an inter-frequency cell reselection.

23. The UE of claim 22, wherein:
the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is different from the configured value of the nrofSS-BlocksToAverage.

24. The UE of claim 22, wherein:
the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is different from the total number of beams of the plurality of beams.

25. A user equipment (UE), comprising:
a transceiver configured to receive, from a 5G new radio (NR) base station (BS), cell reselection information including a first number of beams of a plurality of beams associated with a neighboring cell and configured to be measured for cell reselection of the neighboring cell; and
a processor configured to:
camp in a panic mode on a serving cell of the 5G NR BS, the serving cell associated with a serving cell beam;
sequentially measure a signal quality metric of each beam of a second number of beams of the plurality of beams until a first beam of the second number of beams that is suitable for cell reselection is identified,
a signal quality metric of the first beam exceeding a signal quality metric of the serving cell beam by a threshold amount; and
the second number of beams being less than the first number of beams of the plurality of beams; and
trigger reselection of the neighboring cell based on the measured signal quality metric of the first beam.

26. The UE of claim 25, wherein the reselection of the neighboring cell is an intra-frequency cell reselection.

27. The UE of claim 26, wherein:
the cell reselection information includes a system information block type 2 (SIB2) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is less than the configured value of the nrofSS-BlocksToAverage.

28. The UE of claim 26, wherein:
the cell reselection information includes a system information block type 2 (SIB2) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is less than the total number of beams of the plurality of beams.

29. The UE of claim 25, wherein:
the reselection of the neighboring cell is an inter-frequency cell reselection;
the cell reselection information includes a system information block type 4 (SIB4) associated with the neighboring cell having a configured value of a number of synchronization signal blocks to average for cell measurement derivation (nrofSS-BlocksToAverage), the first number of beams being equal to the nrofSS-BlocksToAverage; and
the second number of beams of the plurality of beams is less than the configured value of the nrofSS-BlocksToAverage.

30. The UE of claim 25, wherein:
the reselection of the neighboring cell is an inter-frequency cell reselection;
the cell reselection information includes a system information block type 4 (SIB4) associated with the neighboring cell lacking a configured value of a number of synchronization signal blocks to average for cell measurement derivation (nrofSS-BlocksToAverage), the first number of beams being equal to a total number of beams of the plurality of beams; and
the second number of beams of the plurality of beams is less than the total number of beams of the plurality of beams.
